(19) United States
(12) Patent Application Publication
(10) Pub. No.: US 2026/0126289 A1
(43) Pub. Date: May 7, 2026

(54) AZIMUTH MEASUREMENT DEVICE

(71) Applicant: Murata Manufacturing Co., Ltd., Nagaokakyo-shi (JP)

(72) Inventor: Shinya KANEDA, Nagaokakyo-shi (JP)

(21) Appl. No.: 19/440,984

(22) Filed: Jan. 6, 2026

Related U.S. Application Data
(63) Continuation of application No. PCT/JP2024/024079, filed on Jul. 3, 2024.

(30) Foreign Application Priority Data
Aug. 29, 2023 (JP) 2023-138507

(51) Int. Cl. G01C 19/5712; G01B 21/22

(52) U.S. Cl. CPC G01C 19/5712; G01B 21/22

(57) ABSTRACT

An azimuth measurement device is provided that includes a first angular velocity sensor, a rotation mechanism, and a second angular velocity sensor. The first angular velocity sensor has a first detection axis extending in a horizontal direction and is configured to detect a first angular velocity around the first detection axis serving as a rotation center. The rotation mechanism has a rotation axis extending in a vertical direction and is configured to rotate the first detection axis of the first angular velocity sensor around the rotation axis serving as a rotation center. The second angular velocity sensor corrects a rotation angle of the first detection axis in the rotation mechanism. The second angular velocity sensor has a second detection axis extending in the vertical direction and is configured to detect a second angular velocity around the second detection axis serving as a rotation center.

### CROSS REFERENCE TO RELATED APPLICATIONS

This application is a continuation of PCT Application No. PCT/JP2024/024079, filed Jul. 3, 2024, which claims priority to Japanese Patent Application No. 2023-138507, filed Aug. 29, 2023, the entire contents of each of which are hereby incorporated by reference in their entireties.

### TECHNICAL FIELD

The present disclosure relates to an azimuth measurement device.

### BACKGROUND

Currently, there are azimuth measurement methods that use azimuth measurement devices, such as an analog magnetic method using a magnetic compass needle, a digital magnetic method using a magnetic sensor, a GPS method, and a method using a gyroscope.

For example, Non-Patent Document 1 (I. P. Prikhodko, S. A. Zotov, Alexander A. Trusov, and A. M. Shkel, “What is MEMS Gyrocompassing? Comparative Analysis of Maytagging and Carouseling” Journal of Microelectromechanical Systems, Vol. 22, No. 6, pp. 1257-1266, December 2013) discloses an azimuth measurement device and an azimuth measurement method. The azimuth measurement device includes a measurement unit for detecting the angular velocity associated with the Earth's rotation. The measurement unit includes an angular velocity sensor having a detection axis extending in a horizontal plane, and the angular velocity sensor is rotated around a vertical axis on a rotation mechanism. Measurement results are then plotted in a graph of which the horizontal axis represents the rotation angle of the detection axis of the angular velocity sensor and the vertical axis represents measured angular velocity. A resulted waveform of the plot is fitted to a sine function to calculate the azimuth.

However, in the azimuth measurement device described in Non-Patent Document 1, if the azimuth measurement device happens to rotate around the vertical axis during the azimuth measurement, the rotation angle of the detection axis of the angular velocity sensor may deviate relative to the reference value, resulting in inaccurate calculation of the azimuth.

### SUMMARY OF THE INVENTION

In view of the foregoing, it is an object of the present disclosure to provide an azimuth measurement device that improves the accuracy of azimuth measurement.

According to an exemplary aspect of the present disclosure, an azimuth measurement device includes a first angular velocity sensor, a rotation mechanism, and a second angular velocity sensor. The first angular velocity sensor has a first detection axis extending in a horizontal direction and is configured to detect a first angular velocity around the first detection axis serving as a rotation center. The rotation mechanism has a rotation axis extending in a vertical direction and is configured to rotate the first detection axis of the first angular velocity sensor around the rotation axis serving as a rotation center. Moreover, the second angular velocity sensor is used to correct a rotation angle of the first detection axis in the rotation mechanism. The second angular velocity sensor has a second detection axis extending in the vertical direction and is configured to detect a second angular velocity around the second detection axis serving as a rotation center.

Accordingly, the exemplary aspects of the present disclosure provide the azimuth measurement device with improved accuracy of azimuth measurement.

### BRIEF DESCRIPTION OF DRAWINGS

FIG. 1 is a schematic diagram illustrating a configuration of an azimuth measurement device according to a first exemplary embodiment.

FIG. 2 is a plan view illustrating a measurement unit.

FIG. 3 is a diagram illustrating an example of a physical configuration of a control unit.

FIG. 4 is a plan view illustrating the measurement unit that is rotated around a vertical axis.

FIG. 5 is a graph of a first angular velocity with respect to a rotation angle before correction.

FIG. 6 is a graph of the first angular velocity with respect to a rotation angle after correction.

FIG. 7 is a schematic diagram illustrating a configuration of an azimuth measurement device according to a second exemplary embodiment.

### DETAILED DESCRIPTION OF EMBODIMENTS

Exemplary embodiments of the present disclosure will be described. In the description of drawings, the same or similar elements are denoted by the same or similar reference signs. The drawings are illustrative, and the dimensions and shapes of elements are schematic. It is noted that the technical scope of the present disclosure should not be interpreted as being limited to the embodiment.

An orthogonal coordinate system formed of an X-axis, a Y-axis, and a Z-axis may be indicated in the drawings for convenience in order to clarify the mutual relationship among the drawings and to help understand the positional relationship of each element. The X-axis, the Y-axis, and the Z-axis correspond to each other among the drawings. According to the present disclosure, the direction parallel to the X-axis is referred to as the “X-axis direction”, and the direction parallel to the Y-axis is referred to as the “Y-axis direction”. Moreover, the direction parallel to the Z-axis is referred to as the “Z-axis direction”. In addition, the direction in which each arrow of the X-axis, the Y-axis, and the Z-axis points is “positive” or “+(plus)”, and the direction opposite to the direction of the arrow pointing is “negative” or “−(minus)”. The plane defined by the X-axis and the Y-axis is the “XY plane”, and the same applies to the other planes defined by other axes. The Z-axis direction is an example of a “vertical direction”, and a direction extending along the XY plane is an example of a “horizontal direction”.

### First Exemplary Embodiment

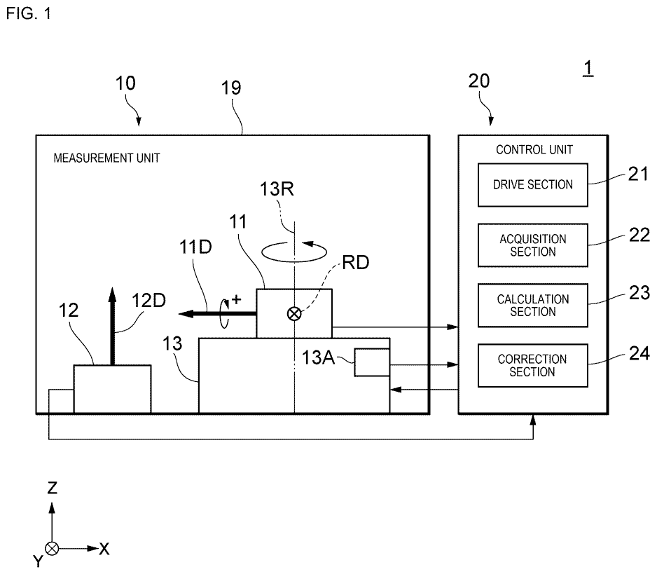

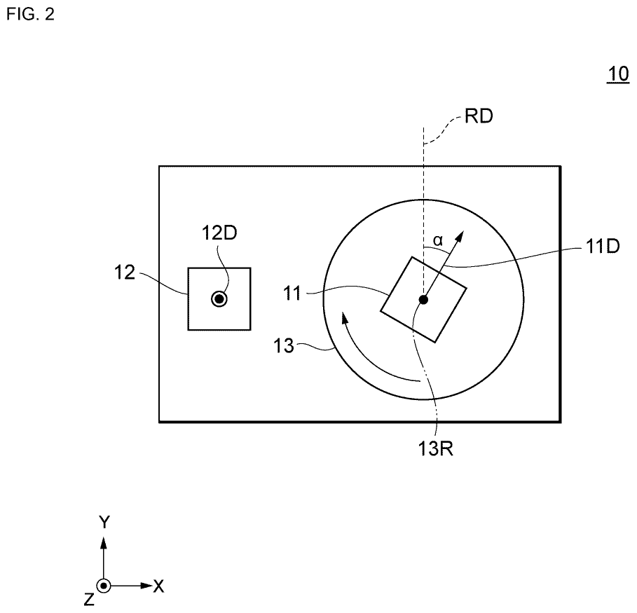

To begin with, the configuration of an azimuth measurement device 1 according to an exemplary embodiment of the present disclosure is described with reference to FIGS. 1 and 2. FIG. 1 is a schematic diagram illustrating a configuration of the azimuth measurement device according to the first exemplary embodiment. FIG. 2 is a plan view illustrating a measurement unit.

The azimuth measurement device 1 is configured to determine the azimuth by measuring the angular velocity of the Earth's rotation. The azimuth measurement device 1 is, for example, a north-finding device that finds the true north direction. The azimuth measurement device 1 includes a measurement unit 10 and a control unit 20.

The measurement unit 10 is configured to measure the angular velocity of the Earth's rotation. As illustrated in FIG. 1, the measurement unit 10 includes a first angular velocity sensor 11, a second angular velocity sensor 12, a rotation mechanism 13, and a sensor housing 19.

The first angular velocity sensor 11 has a first detection axis 11D that extends in a horizontal direction (e.g., first direction along the XY plane) and detects a first angular velocity around the first detection axis 11D as the rotation center. The first angular velocity sensor 11 is, for example, a MEMS (micro-electro-mechanical system) gyro sensor, but it is not limited thereto insofar as the sensor can detect the angular velocity. When the measurement unit 10 is stationary, the first angular velocity corresponds to a component of the angular velocity of the Earth's rotation along the first detection axis 11D that serves as the rotation center, the component being a horizontal component of the angular velocity of the Earth's rotation at the latitude of the measurement point. In other words, the magnitude of the first angular velocity changes in accordance with the azimuth angle of the first detection axis 11D. More specifically, let the angular velocity of the Earth's rotation be ΩE and the latitude of the measurement point be φ. Because the angle between the Earth's axis and the true north direction in the horizontal plane at the measurement point is φ, the horizontal component ωh of the angular velocity of the Earth's rotation with the rotation center extending in the true north direction in the horizontal plane at the measurement point is expressed as ωh=ΩE×cosφ. When the azimuth angle θ of the first detection axis 11D is the angle between the first detection axis 11D and the true north direction in the horizontal plane, the first angular velocity ω, which is derived from the Earth's rotation when the first detection axis 11D serves as the rotation center, is expressed as ω=ωh×cosθ=ΩE×cosφ×cosθ. In the above formula, the angular velocity ω is determined by the latitude φ and the azimuth angle θ of the first detection axis 11D because ΩE is constant (ΩE=15.041 [dph]). When the first detection axis 11D is viewed from the first angular velocity sensor 11, the positive direction of the first angular velocity is clockwise. Under the condition of the azimuth angle θ of the first detection axis 11D being constant, the first angular velocity ω becomes maximum when the measurement location is on the equator (φ=0), and the closer to true north or true south, in other words, the larger the value φ, the smaller the first angular velocity ω becomes. In addition, under the condition of the latitude φ being constant, the first angular velocity ω becomes maximum when the first detection axis 11D points true north, in other words, when θ=0. The first angular velocity ω becomes minimum when the first detection axis 11D points true south, in other words, when θ=180. The first angular velocity ω becomes zero when the first detection axis 11D points true east or true west, in other words, when θ=90 or 270. When the measurement location remains the same, ΩE×cosφ=k (constant). Accordingly, the first angular velocity ω can be expressed as ω=ΩE×cosφ×cosθ=k×sin (90−θ). In other words, the first angular velocity ω can be expressed as a sine function with a variable being the azimuth angle θ of the first detection axis 11D.

The rotation mechanism 13 has a rotation axis 13R extending in the vertical direction (e.g., a second direction along the Z-axis), and the rotation mechanism 13 is configured to rotate the first detection axis 11D of the first angular velocity sensor 11 around the rotation axis 13R, which serves as the rotation center. A rotation angle α of the first detection axis 11D is an angle between the first detection axis 11D rotated by the rotation mechanism 13 and a reference direction RD in the XY plane. For example, the rotation mechanism 13 is a rotating table, and the first angular velocity sensor 11 is fixed onto the table surface of the rotation mechanism 13.

The rotation angle α is measured by a rotary encoder 13A. In the exemplary aspect, the rotary encoder 13A is provided in the rotation mechanism 13, but it may be a component provided outside the rotation mechanism 13 in an alternative aspect.

The second angular velocity sensor 12 is configured to correct the rotation angle α of the first detection axis 11D of the rotation mechanism 13. If the measurement unit 10 rotates around the vertical axis due to an external impact or the like, the first angular velocity sensor 11 rotates together with the rotation mechanism 13 and the rotary encoder 13A. As a result, the rotation angle of the first detection axis 11D deviates from the rotation angle α measured by the rotary encoder 13A. In such a case, the second angular velocity sensor 12 is used to correct the rotation angle α, which is the value measured by the rotary encoder 13A, to obtain the true rotation angle.

The second angular velocity sensor 12 is, for example, a MEMS gyro sensor, as is the case for the first angular velocity sensor 11 but is not limited thereto. The second angular velocity sensor 12 has a second detection axis 12D extending in the vertical direction (e.g., along the Z-axis), and the second angular velocity sensor 12 is configured to detect a second angular velocity around the second detection axis 12D as the rotation center. The second angular velocity is an angular velocity obtained when the measurement unit 10 rotates around the vertical axis due to an external impact or the like. The angular deviation of the orientation of the measurement unit 10 from the reference direction RD can be calculated using the rotation angle obtained by integrating the measurement value of the second angular velocity measured by the second angular velocity sensor 12. The rotation angle α can be thus corrected based on the second angular velocity.

The second angular velocity sensor 12 is disposed at a position spaced from the rotation mechanism 13. In this case, the second angular velocity sensor 12 is configured to detect only the angular velocity of the measurement unit 10 that rotates around the vertical axis thereof. The second angular velocity sensor, however, may be provided on the rotation mechanism as is similar to the first angular velocity sensor. In this case, the second angular velocity sensor detects a composite angular velocity of the angular velocity of the rotation mechanism and the angular velocity of the measurement unit around the vertical axis. Accordingly, the angular velocity of the measurement unit is obtained, for example, by subtracting the angular velocity detected when the measurement unit is stationary from the detected result of the second angular velocity sensor. Alternatively, the angular velocity of the measurement unit may be obtained by subtracting the preset angular velocity of the rotation mechanism from the detected result of the second angular velocity sensor.

As shown, the sensor housing 19 accommodates the first angular velocity sensor 11, the second angular velocity sensor 12, and the rotation mechanism 13. Although not illustrated, the sensor housing 19 may include a communication module that enables the control unit 20 to communicate (e.g., wired or wirelessly) with the first angular velocity sensor 11, the second angular velocity sensor 12, and the rotation mechanism 13.

The control unit 20 is configured to control the measurement unit 10 and to measure the azimuth based on the measurement results of the measurement unit 10. As illustrated in FIG. 1, the control unit 20 is connected to, and communicates with, the measurement unit 10. The control unit 20 includes a drive section 21, an acquisition section 22, a calculation section 23, and a correction section 24.

The drive section 21 is configured to drive the rotation mechanism 13. The acquisition section 22 is configured to acquire the first angular velocity from the first angular velocity sensor 11, the second angular velocity from the second angular velocity sensor 12, and the rotation angle α from the rotary encoder 13A. The calculation section 23 is configured to plot the first angular velocity against the rotation angle α and to calculate the azimuth by fitting the plot with a sine function. The calculation section 23 may be configured to calculate the true north direction from the rotation angle α at the point where the first angular velocity becomes maximum without fitting with a sine function because the first angular velocity becomes maximum when the first detection axis 11D points true north.

In an exemplary aspect, the correction section 24 is configured to correct the rotation angle α of the first detection axis 11D in the rotation mechanism 13 based on the second angular velocity. For example, the correction section 24 can correct the rotation angle α after the rotation angle α is obtained from the rotation mechanism 13 and thereby change the plot position in the calculation section 23. However, the correction method of the correction section 24 is not limited to the above. The correction section 24 may correct the rotation angle α before the rotation angle α is acquired from the rotation mechanism 13. For example, the correction section 24 may set the rotation angular velocity of the rotation mechanism 13 at a value obtained by subtracting the second angular velocity from a preset value for normal conditions of the measurement unit device. Alternatively, the correction section 24 may cause the drive section 21 to rotate the rotation mechanism 13 so as to match the orientation of the rotation mechanism 13 to the true rotation angle. Moreover, the correction section 24 may calibrate the rotary encoder 13A so that the value measured by the rotary encoder 13A can match the true rotation angle.

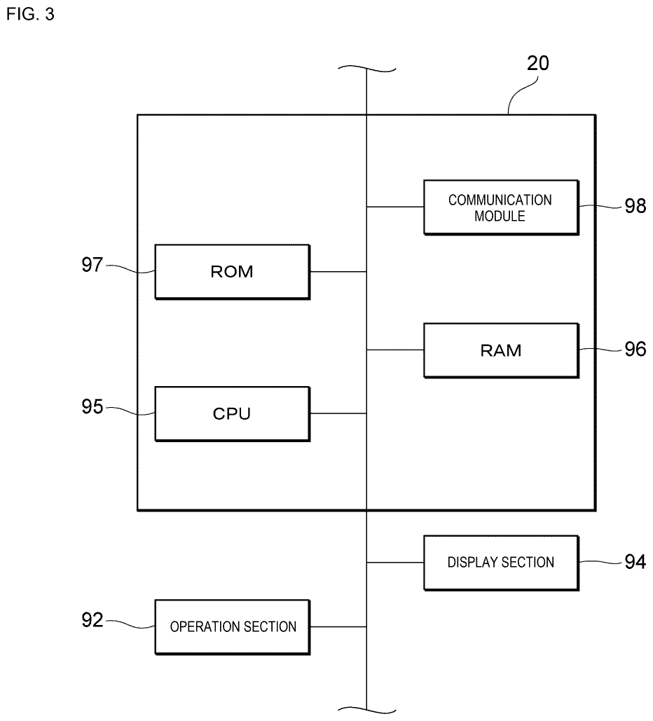

Next, a physical configuration of the control unit 20 will be described with reference to FIG. 3. FIG. 3 is a diagram illustrating an example of a physical configuration of a control unit.

As illustrated, the control unit 20 includes a central processing unit (CPU) 95, a random access memory (RAM) 96, a read only memory (ROM) 97, and a communication module 98. These components are connected to each other via a bus so as to be able to transmit and receive data. The CPU 95, the RAM 96, the ROM 97, and the communication module 98 are connected to an operation section 92 and also to a display section 94 via the bus so as to be able to transmit and receive data. The control unit 20 is, for example, a micro controller unit (MCU). The control unit 20 may be formed of a single computer or may be implemented by combining multiple distributed computers. For example, the control unit 20 can be configured to function and perform the algorithms of the drive section 21, the acquisition section 22, the calculation section 23, and/or the correction section 24 by causing CPU 95 to execute a preset program stored in the RAM 96 or the ROM 97.

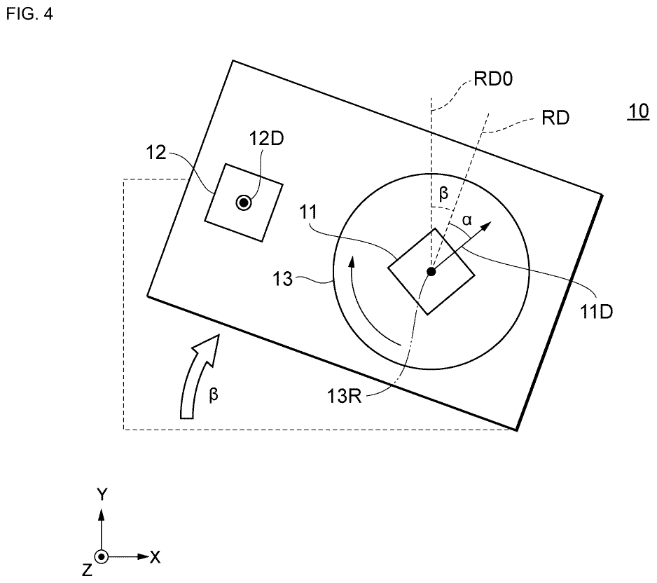

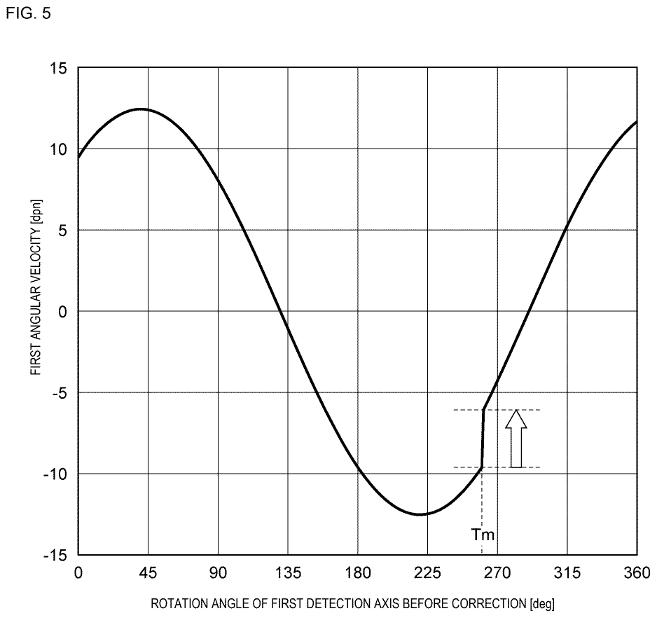

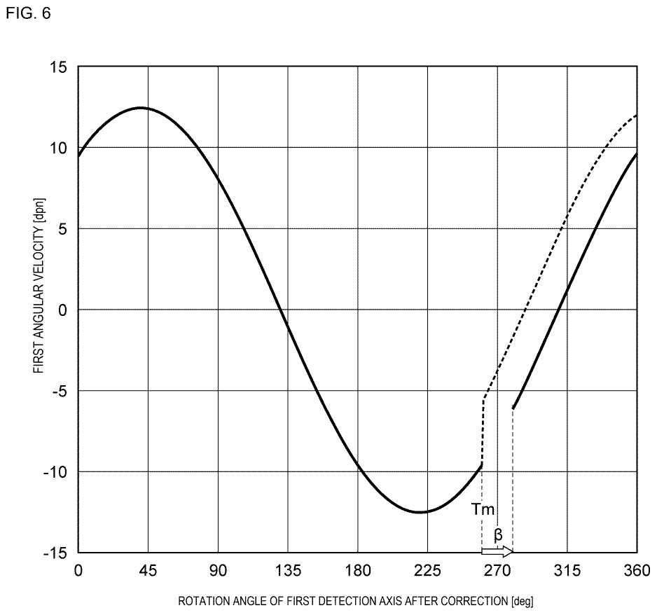

Next, the correction mechanism will be described more in detail with reference to FIGS. 4 to 6. FIG. 4 is a plan view illustrating the measurement unit that has been rotated around the vertical axis. FIG. 5 is a graph illustrating a first angular velocity with respect to a rotation angle before correction. FIG. 6 is a graph illustrating the first angular velocity with respect to a rotation angle after correction. In the graph illustrated in FIG. 5, the horizontal axis represents the rotation angle of the first detection axis 11D before correction, and the vertical axis represents the first angular velocity. In the graph illustrated in FIG. 6, the horizontal axis represents the rotation angle of the first detection axis 11D after correction, and the vertical axis represents the first angular velocity.

The rotation mechanism 13 is actuated first to rotate the first detection axis 11D of the first angular velocity sensor 11 from the reference direction RD. At the same time, the first angular velocity sensor 11 is operated to detect the first angular velocity at predetermined intervals of the rotation angle α.

Assume that as illustrated in FIG. 4, the measurement unit 10 is rotated by an angle β in the same direction as the rotation direction of the rotation mechanism 13 at a timing Tm. When the initial reference direction before rotation is RD0, the reference direction RD of the rotation mechanism 13 is now rotated by an angle β from the initial reference direction RD0. Accordingly, α+β is the true rotation angle of the first detection axis 11D of the first angular velocity sensor 11 from the initial reference direction RD0. Accordingly, when the rotary encoder 13A obtains α as the rotation angle, the first angular velocity sensor 11 detects the first angular velocity at the true rotation angle, which is α+β. As a result, as illustrated in FIG. 5, the first angular velocity changes discontinuously at the timing Tm at which the measurement unit 10 is rotated. If the first angular velocity changes discontinuously in this way, an error will occur when the plot of the first angular velocity is fitted with a sine function.

Accordingly, when the second angular velocity sensor 12 detects the second angular velocity, the correction section 24 can then calculate the angle β on the basis of the second angular velocity. As illustrated in FIG. 6, the correction section 24 adds the rotation angle β to the rotation angle α measured by the rotary encoder 13A after the timing Tm. This operation suppresses the deviation of the plot from the sine function although the plot of the first angular velocity is interrupted once at the timing Tm. In other words, the error caused by fitting with the sine function can be suppressed. Accordingly, the azimuth measurement based on the graph illustrated in FIG. 6 can improve accuracy compared with the case where the azimuth is obtained from the graph as illustrated in FIG. 5. The azimuth angle obtained by fitting using the corrected graph illustrated in FIG. 6 is the azimuth angle with respect to the initial reference direction RD0, in other words, the azimuth angle when the measurement unit 10 is assumed not to be rotated. Accordingly, in order to calculate the azimuth angle of the measurement unit 10 that has been rotated by the angle β, it is necessary to add the rotation angle β of the measurement unit 10 to the azimuth angle obtained by fitting using the corrected graph illustrated in FIG. 6. For example, if the azimuth angle to true north obtained by fitting using the graph after correction is α=30 degrees, and the rotation angle of the measurement unit 10 obtained by integrating the measurement value of the second angular velocity is β=10 degrees, the azimuth angle of the measurement unit 10 to true north is α+β=40 degrees.

As described above, the azimuth measurement device 1 according to the present embodiment includes the first angular velocity sensor 11 that has the first detection axis 11D extending in the horizontal direction. The azimuth measurement device 1 also includes the rotation mechanism 13 configured to rotate the first detection axis 11D around the rotation axis 13R that extends in the vertical direction and serves as the rotation center. The azimuth measurement device 1 further includes the second angular velocity sensor 12 to be used to correct the rotation angle α of the first detection axis 11D in the rotation mechanism 13. The second angular velocity sensor has a second detection axis 12D extending in the vertical direction and is configured to detect the second angular velocity around the second detection axis 12D serving as the rotation center.

According to the configuration described above, even if the measurement unit 10 is rotated around the vertical axis during azimuth measurement, the error in the rotation angle α caused by the rotation of the measurement unit 10 is corrected based on the second angular velocity, which suppresses the occurrence of azimuth measurement error.

The following describes additional exemplary embodiments. It is noted that the same or similar elements as those described in the first embodiment are denoted by the same or similar reference signs, and the description thereof will be omitted as appropriate. In addition, similar advantageous effects provided by similar features will not be repeated.

### Second Exemplary Embodiment

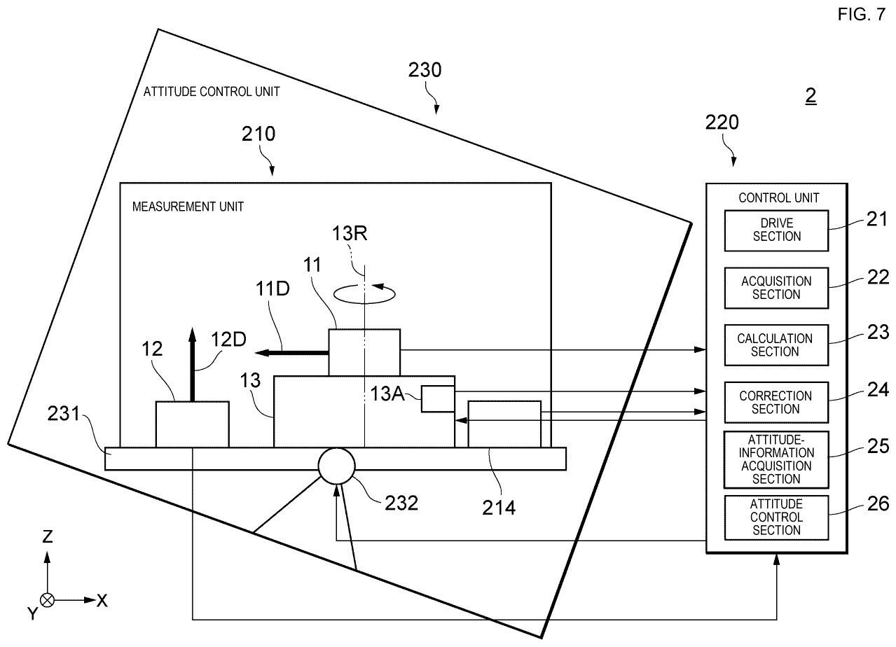

The configuration of an azimuth measurement device 2 according to a second exemplary embodiment will be described with reference to FIG. 7. FIG. 7 is a schematic diagram illustrating a configuration of the azimuth measurement device according to the second exemplary embodiment.

The azimuth measurement device 2 further includes an attitude control unit 230. A measurement unit 210 of the azimuth measurement device 2 is further provided with an attitude measurement mechanism 214. A control unit 220 of the azimuth measurement device 2 is further provided with an attitude-information acquisition section 25 and an attitude control section 26.

The attitude control unit 230 is configured to correct the rotation of the measurement unit 210 around a rotation axis extending in the horizontal direction (e.g., along the XY plane). The attitude control unit 230 is configured to control the attitudes of the first angular velocity sensor 11, the second angular velocity sensor 12, and the rotation mechanism 13. The attitude control unit 230 includes a two-axis gimbal mechanism 231 and a servomotor 232 that operates the two-axis gimbal mechanism 231.

The attitude measurement mechanism 214 is configured to measure the rotation of the measurement unit 210 around a rotation axis extending along the XY plane. In other words, the attitude measurement mechanism 214 measures the attitudes of the first angular velocity sensor 11, the second angular velocity sensor 12, and the rotation mechanism 13. The attitude measurement mechanism 214 is, for example, an inertial measurement unit (IMU). The attitude-information acquisition section 25 acquires information on the attitude of the measurement unit 210 from the attitude measurement mechanism 214. The attitude control section 26 servo-controls the two-axis gimbal mechanism 231 using the servomotor 232 in accordance with the information on the attitude of the measurement unit 210 acquired by the attitude-information acquisition section 25.

According to the present embodiment, the azimuth measurement device 2 is equipped with the attitude control unit 230 that is configured to suppress the occurrence of azimuth measurement errors caused by the rotation of the measurement unit 210 around the rotation axis that extends in the horizontal direction, thereby improving the azimuth measurement accuracy.

Moreover, as one aspect of the present embodiment, the attitude control unit 230 can maintain the horizontal attitude of the measurement unit 210 with high accuracy since the attitude control unit 230 performs attitude control in accordance with the measurement results of the attitude measurement mechanism 214.

In this embodiment, the attitude control unit 230 servo-controls the attitude of the measurement unit 210 in accordance with the measurement results of the attitude measurement mechanism 214, but the present embodiment is not limited to this configuration. That is, the azimuth measurement device may control the attitude of the measurement unit by continuously operating the two-axis gimbal mechanism with a constant output without performing the attitude measurement of the attitude control unit in another exemplary aspect.

Furthermore, the attitude control mechanism is not limited to the two-axis gimbal mechanism. For example, the attitude control mechanism may include two or more columns connected to the bottom surface of the measurement unit, and these columns are provided with lifting functions. The attitude control mechanism may also be a passive-type attitude control mechanism having an air spring, a spring, an oil damper, an air damper, urethane rubber, or the like, according to an exemplary aspect.

As described above, according to an exemplary aspect of the present disclosure, an azimuth measurement device with improved accuracy is provided.

It is noted that the above-described embodiments are provided to facilitate understanding of the exemplary aspects of the present disclosure and are not intended to limit the present invention. The exemplary embodiments may be modified/improved without departing from the spirit of the present disclosure and can include equivalents thereof. In other words, the embodiments and/or the modification examples may be subjected to design changes by a person skilled in the art, but such modifications fall within the scope of the present disclosure insofar as the modifications have characteristic features described herein. For example, the elements and their arrangements, materials, conditions, shapes, sizes, and the like, of the embodiments and/or modification examples are not limited to those described by way of example but may be modified as appropriate. In addition, the embodiments and modification examples are illustrative. The configurations described in different embodiments and/or modification examples can be partially replaced or combined, and such replacements and combinations also fall within the scope of the present disclosure insofar as they have the characteristic features of the present invention.

### REFERENCE SIGNS LIST

1 azimuth measurement device
10 measurement unit
11 first angular velocity sensor
11D first detection axis
12 second angular velocity sensor
12D second detection axis
13 rotation mechanism
13R rotation axis
13A rotary encoder
RD reference direction
α rotation angle
20 control unit
21 drive section
22 acquisition section
23 calculation section
24 correction section
214 attitude measurement mechanism
230 attitude control unit
231 two-axis gimbal mechanism
232 servomotor
25 attitude-information acquisition section
26 attitude control section

1. An azimuth measurement device comprising:
a first angular velocity sensor that has a first detection axis extending in a first direction and is configured to detect a first angular velocity around the first detection axis serving as a rotation center;
a rotation mechanism that has a rotation axis that extends in a second direction orthogonal to the first direction, the rotation mechanism configured to rotate the first detection axis of the first angular velocity sensor around the rotation axis; and
a second angular velocity sensor configured to correct a rotation angle of the first detection axis in the rotation mechanism, the second angular velocity sensor having a second detection axis that extends in the second direction,
wherein the second angular velocity sensor is configured to detect a second angular velocity around the second detection axis serving as a rotation center.

2. The azimuth measurement device according to claim 1, wherein the first direction is a horizontal direction and the second direction is a vertical direction.

3. The azimuth measurement device according to claim 1, further comprising a controller including a correction section that is configured to correct the rotation angle of the first detection axis in the rotation mechanism based on the second angular velocity.

4. The azimuth measurement device according to claim 3, wherein the controller includes a calculation section that is configured to plot the first angular velocity against the rotation angle and to calculate an azimuth by fitting the plot to a sine function.

5. The azimuth measurement device according to claim 3, wherein the correction section is configured to correct the rotation angle after the rotation angle is obtained from the rotation mechanism.

6. The azimuth measurement device according to claim 5, wherein the correction section is configured to add a rotation angle calculated based on the second angular velocity measured by the second angular velocity sensor to the rotation angle of the first detection axis obtained from the rotation mechanism.

7. The azimuth measurement device according to claim 3, wherein the correction section is configured to correct the rotation angle before the rotation angle is obtained from the rotation mechanism.

8. The azimuth measurement device according to claim 7, wherein the correction section is configured to set the rotation angular velocity of the rotation mechanism at a value obtained by subtracting the second angular velocity measured by the second angular velocity sensor from a preset value for normal conditions.

9. The azimuth measurement device according to claim 1, further comprising an attitude control unit configured to control attitudes of the first angular velocity sensor, the rotation mechanism, and the second angular velocity sensor.

10. The azimuth measurement device according to claim 9, wherein the attitude control unit is a two-axis gimbal mechanism.

11. The azimuth measurement device according to claim 9, further comprising an attitude measurement mechanism configured to measure the attitudes of the first angular velocity sensor, the rotation mechanism, and the second angular velocity sensor,
wherein the attitude control unit is configured to control the attitudes based on measurement results of the attitude measurement mechanism.

12. The azimuth measurement device according to claim 3, wherein the controller is a micro controller unit configured to execute a program stored in electronic memory to function as the correction section.

13. The azimuth measurement device according to claim 1, wherein the rotation mechanism includes a rotary encoder configured to measure the rotation angle of the first detection axis in the rotation mechanism.

14. The azimuth measurement device according to claim 1, wherein each of the first angular velocity sensor and the second angular velocity sensor is a MEMS gyro sensor.

15. An azimuth measurement device comprising:
a first angular velocity sensor configured to detect a first angular velocity around a first detection axis extending in a first direction;
a rotation mechanism that has a rotation axis that extends in a second direction orthogonal to the first direction, the rotation mechanism configured to rotate the first angular velocity sensor around the rotation axis; and
a second angular velocity sensor configured to correct a rotation angle of the first detection axis in the rotation mechanism, the second angular velocity sensor having a second detection axis that extends in the second direction,
wherein the second angular velocity sensor is configured to detect a second angular velocity around the second detection axis.

16. The azimuth measurement device according to claim 15, wherein the first direction is a horizontal direction and the second direction is a vertical direction.

17. The azimuth measurement device according to claim 15, further comprising a controller configured to correct the rotation angle of the first detection axis in the rotation mechanism based on the second angular velocity.

18. The azimuth measurement device according to claim 17, wherein the controller is further configured to plot the first angular velocity against the rotation angle and to calculate an azimuth by fitting the plot to a sine function.

19. The azimuth measurement device according to claim 17, wherein the controller is configured to:
correct the rotation angle after the rotation angle is obtained from the rotation mechanism, and
add a rotation angle calculated based on the second angular velocity measured by the second angular velocity sensor to the rotation angle of the first detection axis obtained from the rotation mechanism.

20. The azimuth measurement device according to claim 17, wherein the controller is a micro controller unit configured to execute a program stored in electronic memory to function as the correction section.
